(19) United States
(12) Patent Application Publication
(10) Pub. No.: US 2021/0047036 A1
(43) Pub. Date: Feb. 18, 2021

(54) CONTROLLER AND IMAGING METHOD

(71) Applicant: SZ DJI TECHNOLOGY CO., LTD., Shenzhen (CN)

(72) Inventors: Jiemin ZHOU, Shenzhen (CN); Ming SHAO, Shenzhen (CN); Hui XU, Shenzhen (CN)

(21) Appl. No.: 17/076,555

(22) Filed: Oct. 21, 2020

Related U.S. Application Data
(63) Continuation of application No. PCT/CN2019/083684, filed on Apr. 22, 2019.

(30) Foreign Application Priority Data
Apr. 27, 2018 (JP) 2018-086902

(51) Int. Cl. B64C 39/02; B64D 47/08; G06K 9/62; H04N 5/232

(52) U.S. Cl. CPC B64C 39/024; B64D 47/08; B64C 2201/146; H04N 5/232; B64C 2201/127; G06K 9/62

(57) ABSTRACT

Embodiments of the present disclosure provides an imaging method. The method includes detecting a viewing state of a plurality of viewers; calculating points of interest where straight lines of each gaze direction intersect; determining a position where the points of interest are dense as an imaging position of a scene of interest; and moving a mobile object to the imaging position of the scene of interest and starting imaging.

### CROSS-REFERENCE TO RELATED APPLICATION

This application is a continuation application of International Application No. PCT/CN2019/083684, filed on Apr. 22, 2019, which claims priority to Japanese Application No. 2018-086902, filed on Apr. 27, 2018, the entire contents of both of which are incorporated herein by reference.

### TECHNICAL FIELD

The present disclosure relates to a controller and an imaging method for imaging and automatically detecting the imaging position of a scene of interest.

### BACKGROUND

In various sporting events such as soccer and baseball games, after extracting and editing the scenes of interest from the video materials captured by a camera set up at a specified location of the event venue, the scenes of interest are projected to the electronic bulletin board of the stadium or broadcast to remote audiences via TV or the Internet.

In conventional technology, most of the extraction and editing of the scene of interest are performed manually, which is associated with low work efficiency and high cost. However, methods of automatically extracting the scene of interest from the existing video material rely on the original video material captured by a photographer. Further, in the case of a photographer manually operating the camera, human error sometimes occurs. For example, the photographer may be distracted by other things and miss the scene of interest. In addition, the operation of the camera's imaging direction is generally carried out manually, sometimes the photographer cannot point the camera in the correct direction instantly.

Furthermore, when a fixed camera is disposed at a specified location of the venue, only the same angle of video material can be obtained from one camera. In order to obtain different video materials from multiple angles, cameras and photographers in multiple locations are needed, which leads to high costs.

### SUMMARY

Embodiments of the present disclosure provide an imaging method. The method includes detecting a viewing state of a plurality of viewers; calculating points of interest where straight lines of each gaze direction intersect; determining a position where the points of interest are dense as an imaging position of a scene of interest; and moving a mobile object to the imaging position of the scene of interest and starting imaging.

Embodiments of the present disclosure provide a controller in communication with a mobile object. The controller includes a sightline measurement unit; and a processing unit. The processing unit is configured to detect a viewing state of a plurality of viewers; calculate points of interest where straight lines of each gaze direction intersect when the plurality of viewers are in the viewing state; determine a position where the points of interest are dense as an imaging position of a scene of interest; and move the mobile object to the imaging position of the scene of interest and start imaging.

Embodiments of the present disclosure provide a computer program stored in a storage medium of a computer, when executed by the computer, causes the computer to: detect a viewing state of a plurality of viewers; calculate points of interest where straight lines of each gaze direction intersect when the plurality of viewers are in the viewing state; determine a position where the points of interest are dense as an imaging position of a scene of interest; and move a mobile object to the imaging position of the scene of interest and start imaging.

### BRIEF DESCRIPTION OF THE DRAWINGS

FIG. 1 is a diagram illustrating an example of an appearance of an unmanned aerial vehicle (UAV) in the present disclosure.

FIG. 2 is a block diagram illustrating a hardware configuration of a controller in the present disclosure.

FIG. 3 is a flowchart illustrating the processing steps of an imaging method in the present disclosure.

FIG. 4 is a schematic diagram illustrating an embodiment of the present disclosure.

FIG. 5 is a schematic diagram illustrating an example of a plurality of sightlines of audiences according to the embodiment of the present disclosure.

FIG. 6 is a schematic diagram illustrating points of interest according to the embodiment of the present disclosure.

FIG. 7 is a schematic diagram illustrating imaging positions of the scene of interest according to the embodiment of the present disclosure.

FIG. 8 is a schematic diagram illustrating an audience block according to another embodiment of the present disclosure.

FIG. 9 is a schematic diagram illustrating a plurality of block sightlines according to the embodiment of the present disclosure

FIG. 10 is a schematic diagram illustrating points of interest according to the embodiment of the present disclosure.

FIG. 11 is a schematic diagram illustrating imaging positions of the scene of interest according to the embodiment of the present disclosure.

### REFERENCE NUMERALS

| | |
|---|---|
| 1 | UAV |
| 101 | Camera |
| 102 | Gimbal |
| 200 | Controller |
| 201 | Sightline measurement unit |
| 202 | Processing unit |
| 203 | Antenna |
| 204 | User interface |
| 205 | Display |
| 206 | Memory |

### DETAILED DESCRIPTION OF THE EMBODIMENTS

The technical solutions provided in the embodiments of the present disclosure will be described below with reference to the drawings. However, it should be understood that the following embodiments do not limit the disclosure. It will be appreciated that the described embodiments are some rather than all of the embodiments of the present disclosure. Other embodiments conceived by those having ordinary skills in the art on the basis of the described embodiments without inventive efforts should fall within the scope of the present disclosure. In the situation where the technical solutions described in the embodiments are not conflicting, they can be combined. It should be noted that technical solutions provided in the present disclosure do not require all combinations of the features described in the embodiments of the present disclosure.

The event imaging method of the related to the present disclosure stipulates various processes (steps) in the processing unit of the controller. The “event” mentioned here may include an event surrounded by audiences such as soccer, baseball, football, and basketball games, but the present disclosure is not limited thereto. For example, the event may include a concert, a musical, a circus, a magic show, and other activities with audiences limited to one side of the event.

The controller related to the present disclosure may be a computer capable of communicating with an UAV, and its processing unit can execute the event imaging method of the present disclosure.

The mobile object described in the present disclosure may be a UAV, but the present disclosure is not limited thereto.

The program related to the present disclosure may be a program for causing a computer (including the controller of the present disclosure) to execute various processes (steps).

The recording medium related to the present disclosure may be a recording medium that records a program for causing a computer (including the controller of the present disclosure) to execute various processes (steps).

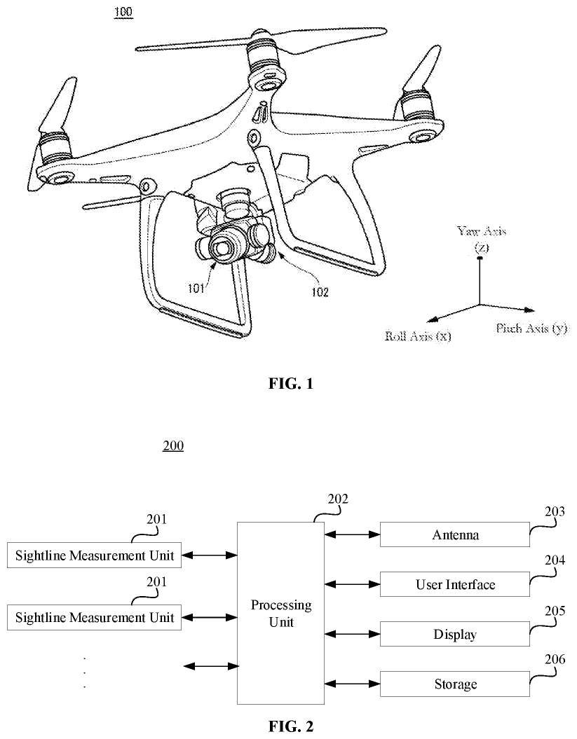

FIG. 1 is a diagram illustrating an example of an appearance of a UAV 100 in the present disclosure. The UAV 100 includes at least a camera 101 and a gimbal 102 in communication with a controller. The communication mentioned here is not limited to a direct communication between the controller and the UAV 100, but may also include indirectly sending and receiving information via any other device. The UAV 100 can move to a predetermined position based on GPS information included in control information received from the controller, and capture images. The movement of the UAV 100 refers to flight, which includes at least ascent, descent, left rotation, right rotation, left horizontal movement, and right horizontal movement. Since the camera 101 is rotatably supported on the gimbal 102 centered on the yaw axis, pitch axis, and roll axis, the direction of the camera 101 may be fixed adjusted by controlling the movement of the gimbal 102. In addition, the specific shape of the UAV 100 is not limited to the shape shown in FIG. 1, as long as it can move and capture images based on a control signal, it may be in any other form.

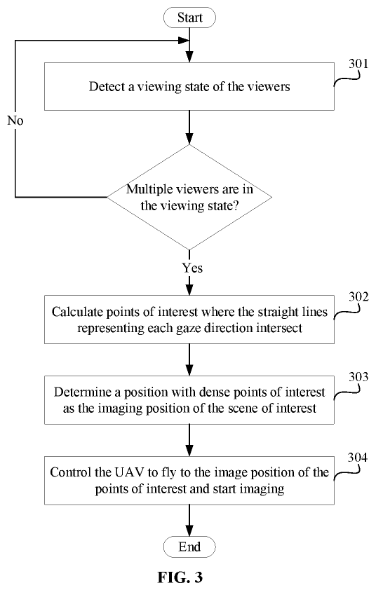

A hardware configuration of the controller of the present disclosure will be described below. As shown in FIG. 2, a controller 200 of the present disclosure includes at least one sightline measurement unit 201, a processing unit 202, and antenna 203, a user interface 204, a display 205, and a memory 206.

The sightline measurement unit 201 may be a sensor that measures the direction of a viewer's line of sight based on eye movements and the like. In some embodiments, for example, the sightline measurement unit 201 may include a camera set toward the auditorium, a goggle worn by an audience, etc., but the present disclosure is not limited thereto. In this embodiment, it is assumed that one sightline measurement unit 201 can measure the sightline of one viewer, therefore, an example including a plurality of sightline measurement unit 201 is illustrated. However, when one sightline measurement unit 201 can measure the sightlines of a plurality of viewers, there may be one sightline measurement unit 201. The sightline measurement unit 201 can be configured to send measured sightline information to the processing unit 202 in a wired or wireless manner.

The processing unit 202 can use a processor, such as a central processing unit (CPU), a micro processing unit (MPU), or a digital signal processor (DSP). The processing unit 202 can be configured to perform signal processing for uniformly controlling the operations of each part of the UAV 100, data input and output processing with other parts, data calculation processing, and data storage processing. The processing unit 202 can execute various processes (steps) in the present disclosure, and generate control information of the UAV 100. In addition, for the ease of description, in the present disclosure, the processing unit 202 is being described as a processing mean. But in fact, the processing unit 202 is not limited to one physical implementation manner. For example, each sightline measurement unit 201 may also include a processor for performing certain calculations, and these processors and the CPU of the controller 200 may jointly constitute the processing unit 202 of the present disclosure.

The antenna 203 can be configured to send the control information generated by the processing unit 202 to the UAV 100 through a wireless signal, and receive needed information from the UAV through a wireless signal. In addition, in the present disclosure, the antenna 203 may also be used to separately communicate with a plurality of UAVs 100. Further, the antenna 203 may be optional for the controller 200. For example, the controller 200 can be configured to send control information to other information terminals such as smart phones, tablets, personal computers, etc. via wires, or can also send the control information to the UAV 100 via an antenna disposed in its information terminal.

The user interface 204 may include a touch screen, buttons, sticks, trackballs, microphone, etc. to accept various inputs from a user. The user can perform various controls through the user interface 204, such as manually control the UAV to move, making the UAV track a specific object, or controlling the movement of the UAV's gimbal to adjust the imaging angle, or controlling the start and end of the a recording. In some embodiments, the user may adjust the camera's exposure and zoom through the user interface 204. In some other embodiments, the user interface 204 may be optional to achieve the purpose of the present disclosure. However, by including the user interface 204 in the controller 200, the operation of the controller 200 can be more flexible.

The display 205 may include an LED, an LCD monitor, etc. The display 205 can display various information, such as information indicating the state of the UAV 100 (speed, altitude, position, battery state, signal strength, etc.), and images captured by the camera 101. When the controller 200 communicates with a plurality of UAVs 100, the information of each UAV 100 can be displayed simultaneously or selectively. In some embodiments, the display 205 may be an optional part to achieve the purpose of the present disclosure. However, by including the display 205 in the controller 200, the user can better understand the state of the UAV 100, the image being captured, the imaging parameters, etc.

The memory 206 may be any computer readable recording medium, which may include at least one of a Static Random Access Memory (SRAM), a Dynamic Random Access Memory (DRAM), an Erasable Programmable Read Only Memory (EPROM), an Electrically Erasable Programmable Read-Only Memory (EEPROM), and a flash memory such as a USB memory. The memory 206 may include a memory for temporarily storing data processed by the processing unit 202 for calculation and a memory for recording data captured by the UAV 100.

Various processes (steps) that can be executed by the processing unit 202 of the controller 200 will be described below in detail with reference to FIG. 3. In addition, these processes constitute the imaging method of the present disclosure. In this embodiment, a collection of codes causing a computer to execute these processes constitutes a program, and a memory storing the collection of codes causing the computer to execute these processes constitutes a storage medium.

301, the processing unit 202 detects a viewing state of the viewers. When a scene of interest occurs, it will attract the attention of many viewers, and the lines of sight will be focused on that position. The present disclosure focuses on this feature, and determines that a scene of interest has occurred by focusing on the viewers' line of sight. The lines of sight can be measured by the sightline measurement unit 201, and the measurement results may be send to the processing unit 202 by a wired or wireless method. In addition, in the present disclosure, it may not be needed to measure the lines of sight of the viewers in the entire venue. Instead, a part of the viewers can be used as a sample to measure the lines of sight.

However, if all lines of sight of the venue are included even when the scene of interest does not occur, the lines of sight of a plurality of viewers may accidentally coincide with each other, and the processing unit 202 may mistake it for the scene of interest. Therefore, the processing unit 202 may determine the viewing state of the view based on the line of sight information acquired from each sightline measurement unit 201, thereby reducing noise. There are various methods for determining the viewing state. For example, when the measured line of sight of the viewer is fixed for more than a predetermined time, it may be detected as a viewing state. In some embodiments, a time threshold may be set to three seconds, but the present disclosure is not limited thereto.

If multiple viewers are not in the viewing state, the processing unit 202 may continue to detect the viewing state of the viewers (the process at 301). At this time, since it means that the viewers' attention is not focused, the processing unit 202 may determine that the scene of interest has not occurred. At a certain time, when multiple viewers are in the viewing state, the processing unit 202 may calculate the points of interest where the straight lines representing each gaze direction intersect (the process at 302).

Next, the processing unit 202 may determine a position where the points of interest are densely focused as an imaging position of the scene of interest (the process at 303). This is because the position where the attention is concentrated may be the position where the viewers' attention is concentrated, which can be the scene of interest for imaging. In addition, the imaging position of the scene of interest determined in the present disclosure is not limited to one position. For example, when there are multiple areas with dense points of interest, the imaging position of the scene of interest may be determined by each area. In some embodiments, when preparing a plurality of UAVs 100, it is also possible to determine the same number of imaging positions of the scene of interest as the UAVs 100. There are many methods to determine the position with dense points of interest, such as the center point of each point of interest. In some embodiments, the processing unit 202 may search for one or more positions with the smallest sum of distances from the respective points of interest, for example, by using the K-means algorithm, but the present disclosure is not limited thereto.

Subsequently, the processing unit 202 may cause the UAV 100 to fly to the imaging position of the scene of interest and start imaging (the process at 304). In some embodiments, the processing unit 202 may generate the control information including GPS information indicating the imaging position of the scene of interest, and send the control information to the UAV 100. After receiving the control information, the UAV 100 can move to the imaging position of the scene of interest based on the GPS information, and start imaging. In some embodiments, moving to the imaging position of the scene of interest mentioned above may also include positions around the imaging position of the scene of interest suitable for the imaging position of the scene of interest. In some embodiments, the processing unit 202 may send instruction information from the user received by the user interface 204 to the UAV at any time. Therefore, the user can adjust the imaging position, the imaging height, the imaging start and end time, etc. of the UAV 100 by using the user interface 204. In addition, when a plurality of imaging positions for a scene of interest are determined in the process at 303, the UAV 100 may be controlled to fly to each imaging position of the scene of interest and start imaging.

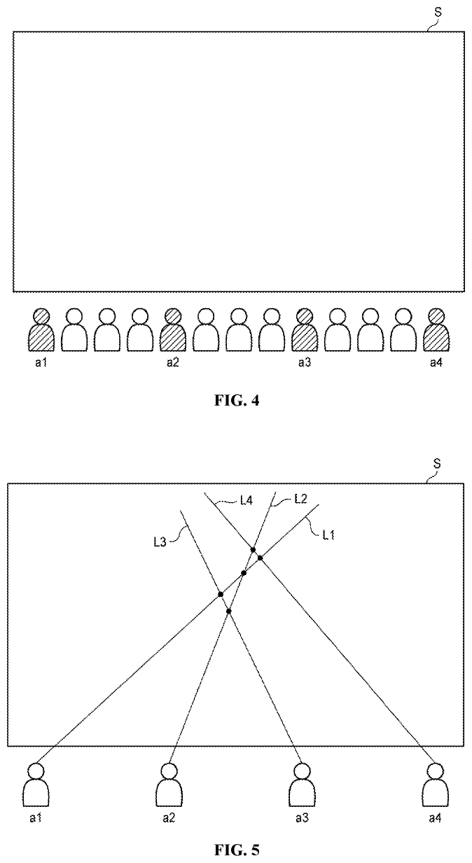

In order to more clearly explain the controller, the imaging method, the program, and the storage medium of the present disclosure, an embodiment of the present disclosure will be described below with reference to FIGS. 4 to 7. In this embodiment, a case where the point of interest is calculated based on the gaze direction of each viewer and the imaging position of a scene of interest is determined are illustrated.

FIG. 4 is a schematic diagram illustrating an embodiment of the present disclosure. As shown in FIG. 4, in this embodiment, a plurality of viewers are in front of a stage S. Further, a plurality of sightline measuring cameras (i.e., the sightline measurement units 201) may be disposed facing a part of or all viewers, and these cameras can continuously measure the sightlines of the viewers. The processing unit 202 may be configured to detect the viewing state by determining whether the sightlines of the viewers measured by these camera are stable for three seconds (i.e., the process at 301).

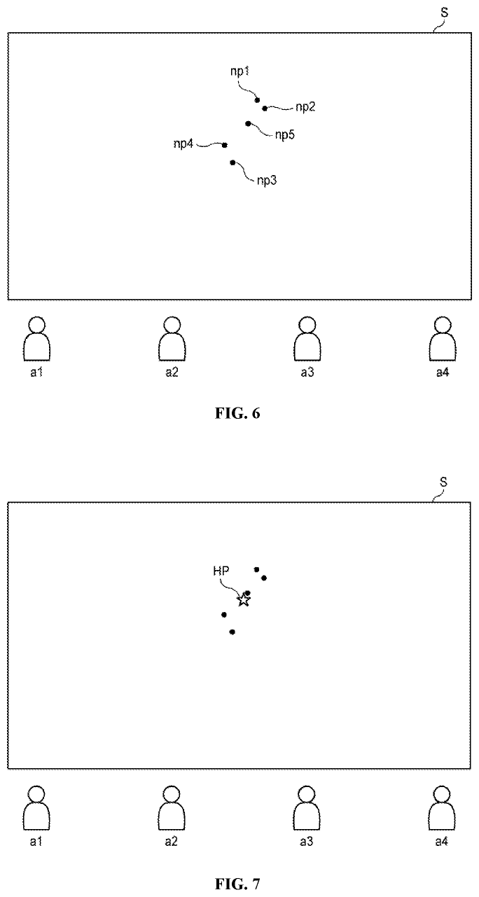

When a scene of interest occurs, the position will attract the attention of many viewers. At this moment, the processing unit 202 can detect that viewers a1, a2, a3, and a4 are in the viewing state based on the information from the camera for the sightline measurement. In FIG. 5, a straight line L1 represents the gaze direction of the viewer a1, a straight line L2 represents the gaze direction of the viewer a2, a straight line L3 represents the gaze direction of the viewer a3, and a straight line L4 represents the gaze direction of the viewer a4. Therefore, the processing unit 202 can calculate the point of interest at which the straight lines representing each gaze direction intersect (i.e., the process at 302). In FIG. 6, a point of interest np1 is the position where the line L2 and the line L4 intersect, a point of interest np2 is the position where the line L1 and the line L4 intersect, a point of interest np3 is the position where the line L2 and the line L3 intersect, a point of interest np4 is the position where the line L1 and the line L3 intersect, and a point of interest np5 is the position where the line L1 and the line L2 intersect. In addition, the straight line L3 and the straight line L4 are also considered to intersect (not shown in FIG. 6), but it is not needed to consider the case where the straight lines intersect outside the stage S.

Subsequently, as shown in FIG. 7, the processing unit 202 determines the center point of the points of interest np1, np2, np3, np4, and np5 as the imaging position of the scene of interest HP (i.e., the process at 303). Then, the processing unit 202 generates the control information including the GPS information of the imaging position HP of the scene of interest, and send it to the UAV 100. After receiving the control information, the UAV 100 moves to the imaging position of the scene of interest based on the GPS information, and start imaging (i.e., the process at 304).

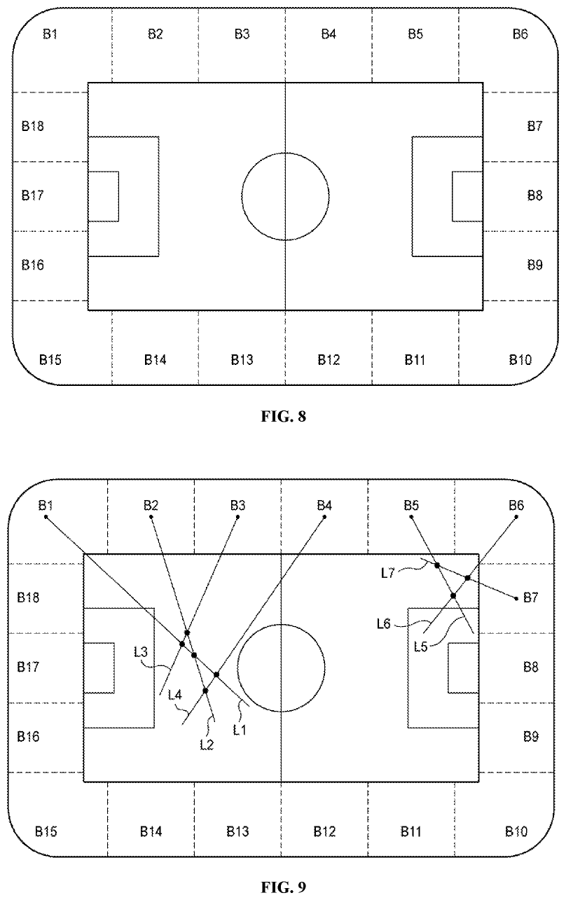

Next, another embodiment of the present disclosure will be described below with reference to FIGS. 8 to 11. In an event held in a large venue such as soccer, there may be many viewers. Therefore, even when a scene of interest has not occurred, there is a high possibility that multiple viewers will be accidentally in the viewing state. In addition, even when a scene of interest occurs, there is a possibility that the calculation load of the processing unit 202 may increase due to too many points of interest. Therefore, in this embodiment, the viewers are divided into a plurality of viewer blocks, and the points of interest are calculated based on the gaze direction of each viewer block.

As shown in FIG. 8, first, the viewers are divided into a plurality of viewer blocks B1˜B18 based on the position of the auditorium, etc. A plurality of sightline measuring cameras (i.e., the sightline measurement units 201) may be disposed in a part of or all of the auditorium in each viewer block, and these cameras can continuously measure the sightlines of the viewers. The processing unit 202 may be configured to detect the viewing state by determining whether the sightlines of the viewers measured by these camera are stable for three seconds (i.e., the process at 301).

When a scene of interest occurs, the position will attract the attention of many viewers. At this moment, the processing unit 202 can detect that multiple viewers are in the viewing state, and calculate a block gaze direction of each viewer block based on the gaze direction of the viewers belong to the block (i.e., the first half of the process at 302). The block gaze direction in this embodiment may be referred to the representative gaze direction of the viewer block. For example, the block gaze direction may include the vector average value of the direction representing the viewers belonging to the viewer block in the viewing state, a unanimous gaze direction of the most viewers, or the gaze direction of a randomly selected viewer, etc., but the present disclosure is not limited thereto. For ease of description, only the gaze directions of the viewer blocks B1 to B7 are shown in FIG. 9, and the gaze directions of the viewer blocks B8 to B18 are omitted. More specifically, a straight line L1 represents the gaze direction of the viewer block B1, a straight line L2 represents the gaze direction of the viewer block B2, a straight line L3 represents the gaze direction of the viewer block B3, a straight line L4 represents the gaze direction of the viewer block B4, a straight line L5 represents the gaze direction of the viewer block B5, a straight line L6 represents the gaze direction of the viewer block B6, and a straight line L7 represents the gaze direction of the viewer block B7.

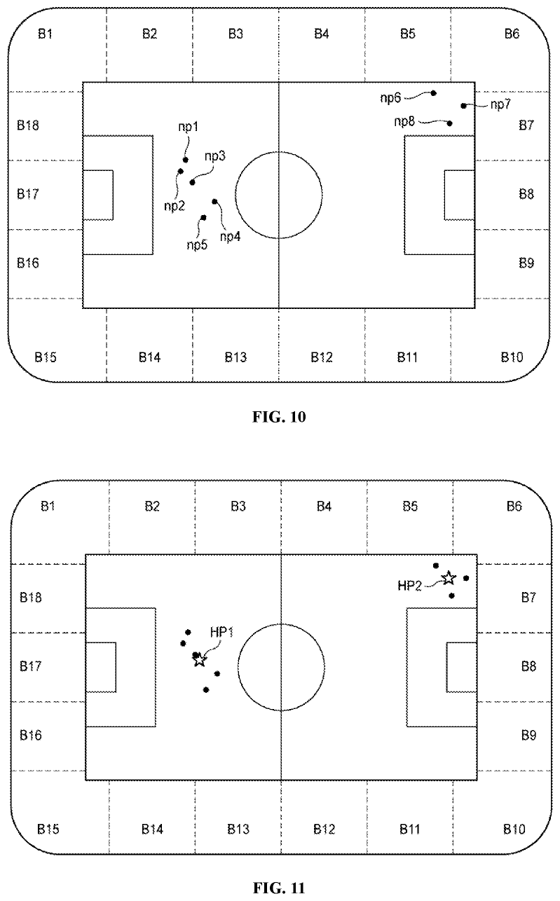

Next, the processing unit 202 can calculate the points of interest at which the gaze directions of each viewer block intersect (i.e., the second half of the process at 302). In FIG. 10, a point of interest np1 is the position where the line L2 and the line L3 intersect, a point of interest np2 is the position where the line L1 and the line L3 intersect, a point of interest np3 is the position where the line L1 and the line L2 intersect, a point of interest np4 is the position where the line L1 and the line L4 intersect, a point of interest np5 is the position where the line L2 and the line L4 intersect, a point of interest np6 is the position where the line L5 and the line L7 intersect, a point of interest np7 is the position where the line L6 and the line L7 intersect, and a point of interest np8 is the position where the line L5 and the line L6 intersect. In addition, for example, the straight line L3 and the straight line L4 may also intersect at a position (not shown in FIG. 10), but it is not needed to consider the case where the straight lines intersect outside the stage S.

In addition, in this embodiment, since there are two UAVs 100, the processing unit 202 may determine two imaging positions of the scene of interest HP1 and HP2 as shown in FIG. 11 with dense points of interest (i.e., the process at 303). Further, the processing unit 202 may generate the control information including the GPS information of the imaging position of the scene of interest HP1 and the control information including the GPS information of the imaging position of the scene of interest HP2, and send the control information to different UAVs 100 respectively. After the two UAVs 100 receive the control information, the two UAVs 100 can move to the imaging position of the point of interest HP1 and the imaging position of the point of interest HP2 based on the GPS information, and start imaging (i.e., the process at 304).

In some embodiments, the information captured in different scenes of interest may be sent to different displays. For example, since the imaging position of the scene of interest HP1 is obtained based on the sightline information of the viewers belonging to the view blocks B1˜B4, the video captured by the UAV 100 at the imaging position of the scene of interest HP1 may be output to a display facing the viewers belonging to the viewer blocks B1˜B4. Similarly, since the imaging position of the scene of interest HP2 is obtained based on the sightline information of the viewers belonging to the view blocks B5˜B7, the video captured by the UAV 100 at the imaging position of the scene of interest HP2 may be output to a display facing the viewers belonging to the viewer blocks B5˜B7.

By using the imaging method, controller, program, and storage medium of the present disclosure, since the scene of interest is automatically detected based on the gaze directions of a plurality of viewers, the UAV can fly to the point of interest and capture images, which can prevent missing precious moments due to human error. In addition, since the UAV can capture images at any angle, there is no need to use multiple cameras and photographers, which can reduce the cost.

The technical solution of the present disclosure have been described by using the various embodiments mentioned above. However, the technical scope of the present disclosure is not limited to the above-described embodiments. It should be obvious to one skilled in the art that various modifications and improvements may be made to the embodiments. It should also obvious from the scope of claims of the present disclosure that thus modified and improved embodiments are included in the technical scope of the present disclosure.

As long as terms such as “before,” “previous,” etc. are not specifically stated, and as long as the output of the previous processing is not used in the subsequent processing, the execution order of the processes, sequences, steps, and stages in the devices, systems, programs, and methods illustrated in the claims, the description, and the drawings may be implement in any order. For convenience, the operation flows in the claims, description, and drawing have been described using terms such as “first,” “next,” etc., however, it does not mean these steps must be implemented in this order.

The specific embodiments described above are not intended to limit the scope of the present disclosure. Any corresponding change and variation performed according to the technical idea of the present disclosure shall fall within the protection scope of the claims of the present disclosure.

What is claimed is:

1. An imaging method, comprising:
detecting a viewing state of a plurality of viewers;
calculating points of interest where straight lines of each gaze direction intersect;
determining a position where the points of interest are dense as an imaging position of a scene of interest; and
moving a mobile object to the imaging position of the scene of interest and starting imaging.

2. The imaging method of claim 1, further comprising:
measuring sightlines of the plurality of viewers; and
determining the viewing state in response to the sightlines being stabilized for more than a period of time.

3. The imaging method of claim 1, wherein determining the position where the points of interest are dense as the imaging position of the scene of interest includes:
determining a center point of each point of interest as the imaging position of the scene of interest.

4. The imaging method of claim 3, wherein determining the position where the points of interest are dense as the imaging position of the scene of interest includes:
determining the imaging positions of a plurality of scenes of interest where the points of interest are dense, and
moving the mobile object to the imaging position of the scene of interest and starting imaging includes:
moving each mobile object to the imaging positions of the plurality of scenes of interest and starting imaging.

5. The imaging method of claim 4, further comprising:
sending information captured at different imaging positions of the scenes of interest to different displays.

6. The imaging method of claim 5, wherein the plurality of viewers are divided into a plurality of viewer blocks, and calculating the points of interest where straight lines of each gaze direction intersect includes:
for each viewer block, calculating a block gaze direction based on the gaze directions of the viewers belonging to the viewer block; and
calculating the points of interest where the block gaze directions intersect.

7. The imaging method of claim 1, wherein, for each viewer block, calculating the block gaze direction based on the gaze directions of the viewers belonging to the viewer includes:
using a direction in which most viewers belonging to the viewer block with a same sightline as the block gaze direction.

8. A controller in communication with a mobile object, comprising:
a sightline measurement unit; and
a processing unit configured to:
detect a viewing state of a plurality of viewers;
calculate points of interest where straight lines of each gaze direction intersect when the plurality of viewers are in the viewing state;
determine a position where the points of interest are dense as an imaging position of a scene of interest; and
move the mobile object to the imaging position of the scene of interest and start imaging.

9. The controller of claim 8, wherein the processing unit is further configured to:
determine the viewing state in response to the viewers' sightlines being measured by the sightline measurement unit have stabilized for more than a period of time.

10. The controller of claim 8, wherein the processing unit is further configured to:
determine a center point of each point of interest as the imaging position of the scene of interest.

11. The controller of claim 10, wherein the processing unit is further configured to:
determine the imaging positions of a plurality of scenes of interest where the points of interest are dense, and
move each mobile object to the imaging positions of the plurality of scenes of interest and to start imaging.

12. The controller of claim 11, wherein the processing unit is further configured to:
send information captured at different imaging positions of the scenes of interest to different displays.

13. The controller of claim 8, wherein:
the plurality of viewers are divided into a plurality of viewer blocks, and the processing unit is further configured to calculate a block gaze direction based on the gaze directions of the viewers belonging to the viewer block for each viewer block, and calculate the points of interest where the block gaze directions intersect.

14. The controller of claim 13, wherein the processing unit is further configured to:
determine a direction in which most viewers belonging to the viewer block with a same sightline as the block gaze direction.

15. A computer program stored in a storage medium of a computer, when executed by the computer, causes the computer to:
detect a viewing state of a plurality of viewers;
calculate points of interest where straight lines of each gaze direction intersect when the plurality of viewers are in the viewing state;
determine a position where the points of interest are dense as an imaging position of a scene of interest; and move a mobile object to the imaging position of the scene of interest and start imaging.
